(19) United States
(12) Patent Application Publication
(10) Pub. No.: US 2020/0073906 A1
(43) Pub. Date: Mar. 5, 2020

(54) Method, Device, Storage Medium and Processor for Data Acquisition and Query

(71) Applicant: BEIJING GRIDSUM TECHNOLOGY CO., LTD., Beijing (CN)

(72) Inventor: Andi WANG, beijing (CN)

(21) Appl. No.: 16/610,962

(22) PCT Filed: Jun. 8, 2018
(86) PCT No.: PCT/CN2018/090402

§ 371 Date: Nov. 5, 2019

(30) Foreign Application Priority Data
Jun. 15, 2017 (CN) 201710453313.6

(51) Int. Cl. G06F 16/957; G06F 11/34; G06F 16/9032; G06F 11/30; G06F 16/9538

(52) U.S. Cl. CPC G06F 16/9577; G06F 11/3438; G06F 16/9538; G06F 11/3082; G06F 16/90324

(57) ABSTRACT

The invention discloses a method and a device, a storage medium and a processor for data acquisition and query, and relates to the technical field of computers, with a major object to ensure that at a front end, not only the times of clicks on and accesses to elements can be viewed, but also data of the associated elements can be displayed. The data acquisition method comprises: receiving custom data acquisition information; generating a first configuration file according to the custom data acquisition information; reading the first configuration file, acquiring monitored website data according to the first configuration file, sending the monitored website data to a server side, further defining the monitored website data according to path information corresponding to the acquired monitored website data to generate a second configuration file; and sending the second configuration file to a server so that the server generates query data according to the second configuration file. The invention is mainly used for acquisition and query of monitored website data.

The present application is filed on the basis of and claims priority from a Chinese patent application having an application number 201710453313.6, filed on Jun. 15, 2017, which is incorporated herein by reference in its entirety.

### TECHNICAL FIELD

The invention relates to the technical field of computers, in particular to a method and a device, a storage medium and a processor for data acquisition and query.

### BACKGROUND ART

With the rapid development of Internet data industry, more and more Internet companies begin to attach importance to the application of data, work on mining and analyzing the behavior and preferences of users out of enormous and miscellaneous data, and adjust to improve the enterprises themselves according to user requirements. In the prior art, the website research and development process requires a large amount of data, the data can be obtained through a corresponding data acquisition request sent to a back end from a front end, and then displayed at the front end. At present, the mainstream website analysis tools generally use front-end data monitoring technology to acquire user access behavior data and system information data at a web-end, and send the acquired data to a server so that the server can analyze the acquired data, and when the user queries the data, the acquired data result can be displayed at the front end.

The data acquisition method in the prior art mainly comprises: (1) initiating buried points in codes of data through pre-written JavaScript monitoring codes when operation of a control occurs, and then acquiring operation data of the control, such as burying points for element clicks or element text change, by which means, however, points have to be buried at a client website and codes have to be added at buried points for every control, requiring a lot work to be done; and (2) at first, acquiring all the data at a client website by adopting a non-buried-point technology, without additional buried-point operation, and then selecting “non-buried point” of objects to be analyzed at a back end, so that operation data of the objects to be analyzed are acquired; however, “non-buried-point” technology may apply only to some simple operation statistics, such as the times of clicks on a button and time, etc., but fail to acquire detailed data in more complex applications, such as payment events, statistics of commodity names and prices, etc.

### SUMMARY OF THE INVENTION

In view of the above problems, the present invention has been made to provide a method, a device, a storage medium and a processor for data acquisition and query that overcomes or at least partially solves the above problems, enabling that not only the times of clicks on and accesses to elements are viewed at a front end, but also other monitored data can be displayed.

According to one aspect of the embodiment of the invention, the embodiment of the invention provides a data acquisition method, which can be applied to a client and comprises:

receiving custom data acquisition information;

generating a first configuration file according to the custom data acquisition information; and

reading the first configuration file, acquiring monitored website data according to the first configuration file and sending the monitored website data to a server side.

Further, receiving the custom data acquisition information comprises:

positioning predefined data from page information;

determining data associated with the predefined data according to selection operation of a user; and

obtaining the custom data acquisition information according to the data associated with the predefined data and the predefined data.

In order to achieve the above object, according to another aspect of the present invention, a storage medium is provided, including a stored program, wherein a device in which the storage medium locates is controlled to execute the above-described data acquisition method when the program is running.

In order to achieve the above object, according to another aspect of the present invention, a processor is provided for running a program, wherein the program executes the above-described data acquisition method when running.

According to another aspect of the embodiment of the invention, the embodiment of the invention provides a data query method, which can be applied to a client and comprises:

defining the monitored website data according to the path information corresponding to the monitored website data to generate a second configuration file; and sending the second configuration file to a server so that the server generates query data according to the second configuration file.

Further, defining the monitored website data according to the path information corresponding to the monitored website data to generate a second configuration file comprises:

acquiring path information corresponding to the monitored website data by means of a website analysis tool; and

defining monitored website data under the same path according to the path information to generate a second configuration file.

Further, the method further comprises:

receiving query data fed back by the server according to a query request sent by a user; and

displaying the query data.

Further, before receiving the query data fed back by the server according to the query request sent by the user, the method further comprises the steps of:

receiving custom query information; and

generating a query request according to the custom query information and sending the query request to a server side.

In order to achieve the above object, according to another aspect of the present invention, a storage medium is provided, including a stored program, wherein a device in which the storage medium locates is controlled to execute the above-described data query method when the program is running.

In order to achieve the above object, according to another aspect of the present invention, a processor is provided for running a program, wherein the program executes the data query method described above when running.

According to another aspect of the embodiment of the invention, the embodiment of the invention provides a data acquisition device, comprising:

a receiving unit for receiving the custom data acquisition information;

a generating unit for generating a first configuration file according to the custom data acquisition information; and

a reading unit for reading the first configuration file, acquiring monitored website data according to the first configuration file and sending the monitored website data to a server side.

Further, the receiving unit comprises:

a positioning module for positioning the predefined data from page information;

a determination module for determining the data associated with the predefined data according to selection operation of a user; and

a receiving module for obtaining custom data acquisition information according to the data associated with the predefined data and the predefined data.

According to another aspect of the embodiment of the invention, the embodiment of the invention provides a data query device, comprising:

a definition unit for defining the monitored website data according to the path information corresponding to the monitored website data to generate a second configuration file; and

a sending unit for sending the second configuration file to a server so that the server can generate query data according to the second configuration file.

Further, the definition unit comprises:

an acquisition module for acquiring path information corresponding to the monitored website data by means a website analysis tool; and

a definition module for defining monitored website data under the same path according to the path information to generate a second configuration file.

By means of the above technical solution, the data acquisition and query method and the data acquisition and query device provided by the invention have the following advantages: in the data acquisition process, a client generates a first configuration file at the client by receiving the custom data acquisition information, and then acquires monitored website data according to the first configuration file and sends the monitored website data to a server, so that acquired element data and element data associated therewith can be selectively required; furthermore, when the user queries the data, the client can define the monitored website data according to path information corresponding to the acquired monitored website data to generate a second configuration file, so that the server can conveniently generate the query data according to the second configuration file. Compared with the data acquisition and query method in the prior art, the client in the embodiment of the invention carries the monitored website data after being defined according to the path information while sending the acquired monitored website data to the server, so that business personnel can directly carry out data definition, frequent communication with the website party is avoided to a certain extent, and the costs are reduced. In addition, the server analyzes according to the defined monitored website data, binds the elements under the same path to the same event, and enables the client to not only view the times of clicks on and the accesses to an element, but also display the associated data with the element when data are queried by clicking on and positioning at the specific element. The above description is merely an summary of the technical solution of the present invention, and in order to render a more clear understanding of the technical means of the present invention and implement in accordance with the description, and in order that the above and other objects, features and advantages of the present invention may be more readily apparent, specific embodiments of the present invention are hereinafter set forth.

### BRIEF DESCRIPTION OF THE DRAWINGS

Those of ordinary skill in the art will understand various and other advantages and benefits in a more apparent manner upon reading the following detailed description of the preferred embodiments. The drawings are only for the purpose of illustration and are not to be construed as limiting the invention. Moreover, throughout the drawings, like reference numerals refer to like parts. In the drawings:

FIG. 1 is a flow diagram illustrating a data acquisition method according to an embodiment of the present invention;

FIG. 2 is a flow diagram illustrating a data query method provided by an embodiment of the present invention;

FIG. 3 is a flow diagram illustrating another data query method provided by an embodiment of the present invention;

FIG. 4 is a block diagram illustrating a data acquisition device according to an embodiment of the present invention;

FIG. 5 illustrates a block diagram of another data acquisition device provided by an embodiment of the present invention;

FIG. 6 is a block diagram illustrating a data query device according to an embodiment of the present invention;

FIG. 7 illustrates a block diagram of another data query device provided by an embodiment of the present invention.

### DETAILED DESCRIPTION OF THE INVENTION

Exemplary embodiments of the present disclosure will be described in more detail below with reference to the accompanying drawings. Although exemplary embodiments of the present disclosure are shown in the drawings, it is to be understood that the present disclosure may be embodied in various forms and should not be limited to the embodiments set forth herein. Rather, these embodiments are provided to render a thorough and complete understanding and fully convey the scope of the disclosure to those skilled in the art.

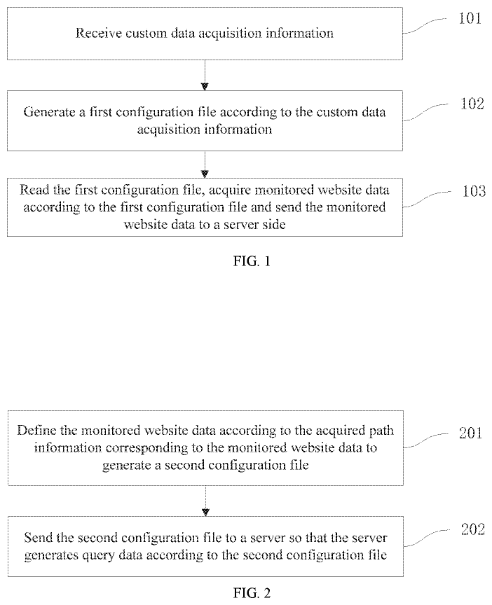

The embodiment of the invention provides a data acquisition method, which is mainly applied to a client and can acquire corresponding data from monitored website data according to received custom data acquisition information and then send the corresponding data to a server side as shown in FIG. 1.

101. Receiving custom data acquisition information.

The custom data acquisition information refers to acquiring data information of a certain element and associated elements in a webpage in a custom acquisition mode, and it is not limited to the acquisition of clicks on and accesses to the certain element, an operation event of the element can be customized so as to carry data information of associated elements, for example, a click event of a purchase button can be customized to carry prices, quantity and other data information of associated elements. It should be explained that the data information of the associated elements needs to be acquired from the associated elements, when an operation event of a certain element occurs, the data information of the element and the data information of the associated elements are simultaneously acquired.

Specifically, receiving custom data acquisition information includes: firstly, positioning predefined data from page information, wherein the predefined data can be data corresponding to any element in the page, then determining data associated with the predefined data according to selection operation of a user, such as whether an event corresponding to a custom element carries data of other associated elements or not, if the event carries the associated data, further positioning at the associated element and acquiring the data from the associated element, and then obtaining custom data acquisition information according to the data associated with the predefined data and the predefined data, for example, when clicking a purchase element, simultaneously customizing order information associated with the purchase element into the purchase element, or when clicking a search element, simultaneously customizing variable elements in a search box associated with the search box element into the search element.

According to the embodiment of the invention, by receiving the custom data acquisition information, it can be customized regarding whether the acquired element data carries other associated data or not, different parameters can be carried at one time, convenience is provided for subsequent data query by a user, multiple data queries are avoided, and the costs of a website are reduced to a certain extent.

102. Generating a first configuration file according to the custom data acquisition information.

It should be explained that the embodiment of the present invention does not limit the storage format of the custom data acquisition information in the first configuration file, and the format may be XML, YAML, JASN or the like, and the data acquisition information may be updated at preset intervals. If more associated data are required to be carried by an element, such as adding order remarks in the event of a purchase button or other associated data, if can be achieved by updating the first configuration file.

103. Reading the first configuration file, acquiring monitored website data according to the first configuration file and sending the monitored website data to a server side. The monitored website data refers to obtaining data flow of a website by monitoring the website, the data monitored are different with regard to different enterprises or users, for example, the data monitored by a marketing enterprise mainly comprise access data of a marketing website and a third-party platform, as well as data of trading volume; the data monitored by a user as a purchaser mainly comprise the trading volume data and reputation data of the marketing website, and the like. In order to better maintain the customer relationship, the marketing enterprise also monitors the browsing data of the customer, and timely recommends relevant products that may interest the customer. The embodiment of the invention does not limit the content of the monitored website data.

It should be explained that the first configuration file in the embodiment of the present invention can be sent to the server side for storage or can be stored at the client for updating in real time according to the change of the custom data acquisition information, and the storage position of the first configuration file is not limited by the embodiment of the present invention.

According to the embodiment of the invention, the monitored website data can be acquired through a website analysis tool, such as various website analysis tools as Baidu Statistics, Google Analysis, Tencent Statistics and the like; the trend of the website can be grasped through the monitored website data, and the associated data of each page of the website can be collected as statistics.

Specifically, during data acquisition, the first configuration file is read firstly, monitored website data are acquired according to the first configuration file containing the custom data acquisition information, and the custom requirements of different users can be met. In the application, different data can be acquired by means of buried points or other modes according to the requirements of different customers, for example, an e-commerce seller pays more attention to the purchase data of a user, so the seller buries points in purchase elements in a webpage to obtain the purchase data of the user; an enterprise pays more attention to the browsing data of a website, so the enterprises buries points at the positions triggering the browsing webpage elements to obtain the browsing data of the website.

Specifically, during data acquisition, websites are monitored by trying to acquire operation data of webpage elements of all the websites by means of non-buried-point technology in advance, so as to obtain the monitored data of all the websites, and the acquired monitored data of the websites are filtered by reading a first configuration file to configure which data need to be analyzed on a server. It will be appreciated that the no-buried-point technology has been performing data acquisition since the software development kit (SDK) was deployed. In addition, the no-buried-point technology can automatically obtain a lot of heuristic information, for example, telling the user how many times each element is clicked on the interface, how likely each element is clicked, and which elements are worth further analysis, etc.

It can be seen from the above embodiment, according to the data acquisition method provided by the embodiment of the invention, during data acquisition, a client generates a first configuration file at the client by receiving the custom data acquisition information, and then acquires monitored website data according to the first configuration file and sends the monitored website data to a server, so that element data to be acquired and associated element data can be selected according to user requirements. Compared with the data acquisition method in the prior art, before the client of the present invention sends the monitored website data to the server, the first configuration file generated by the custom data acquisition information is used for acquiring the monitored website data, so that the acquired monitored website data are more standard, facilitating classification of the monitored website data by the server, and meanwhile, the front end is facilitated to query the data according to different query conditions.

The embodiment of the invention provides a data query method, as shown in FIG. 2, which is mainly applied to a client and can define the acquired monitored website data so as to send the defined monitored website data to a server side, specifically comprising:

201. Defining the monitored website data according to the acquired path information corresponding to the monitored website data to generate a second configuration file.

The path information herein can be a path corresponding to an element clicked by the user after entering the website, for example, the path clicked by the user to purchase can be as follows: search the target item→go through the detailed information of the item→add the item to the shopping cart→select delivery information→confirm and pay, obviously some elements can be added or reduced in this path clicked to purchase, such as adding an element to modify delivery information or reducing an element to add the item to the shopping cart and other associated elements. According to the embodiment of the invention, elements involved in the path information are not specified, and different monitored website data correspond to their respective path information.

For the embodiment of the invention, monitored website data under the same path are categorized into integral part by defining monitored website data of different path information, for example, browsing data of a certain commodity browsed by a user, data of a certain commodity labeled as favorite by the user and data of adding a commodity to the shopping cart by the user are defined as purchase data about a certain commodity by the user, and obviously, the monitored website data with interactivity can be categorized under different defined names, the embodiment of the present invention does not intend to be limiting in this case.

Because the monitored website data have diversity, and the monitored website data under different paths also interact with each other, the embodiment of the invention defines the monitored website data according to the path information, saves the defined monitored website data to the second configuration file so as to facilitate the management of the monitored website data at the front end, analyzes the monitored website data from different dimensions, and displays the monitored website data with different path information. Meanwhile, more data information can be displayed to the user, and the query experience of the user is improved.

It should be noted that the second configuration file includes not only monitored website data defined according to the path information, but also elements defined according to the path information and events corresponding to the elements. If a click event corresponding to an element occurs, data of all elements in the path information corresponding to the element or data of several key elements in the path information corresponding to the element are defined into the same click event, for example, a user payment element click event occurs, and several key elements in the path information corresponding to the payment element include price, purchase quantity and remark information corresponding to the commodity for which is paid.

202. Sending the second configuration file to a server so that the server generates query data according to the second configuration file.

The query data herein is query data generated by analyzing a second configuration file by a server, the server binds the data under the same path information element to a redefined event, when the redefined event occurs, the query data are generated according to the data of the path information element corresponding to the event, and the query data can include the data of all the elements in the path information, and also data of several key elements in the path information; the embodiment of the present invention does not limit the content of the query data.

According to the data query method provided by the embodiment of the invention, when the user queries the data, the client can define the monitored website data according to the acquired path information corresponding to the monitored website data to generate a second configuration file, so that the server can conveniently generate the query data according to the second configuration file. Compared with the data query method in the prior art, the client in the embodiment of the invention carries the defined monitored website data according to the path information while sending the acquired monitored website data to the server, so that business personnel can directly define the data, frequent communication with the website party is avoided to a certain extent, and the costs are reduced. In addition, the server analyzes according to the defined monitored website data, binds the elements under the same path to the same event, and enables the client to not only view the times of clicks on and the accesses to an element, but also display the associated data with the element when data are queried by clicking and positioning at the specific element.

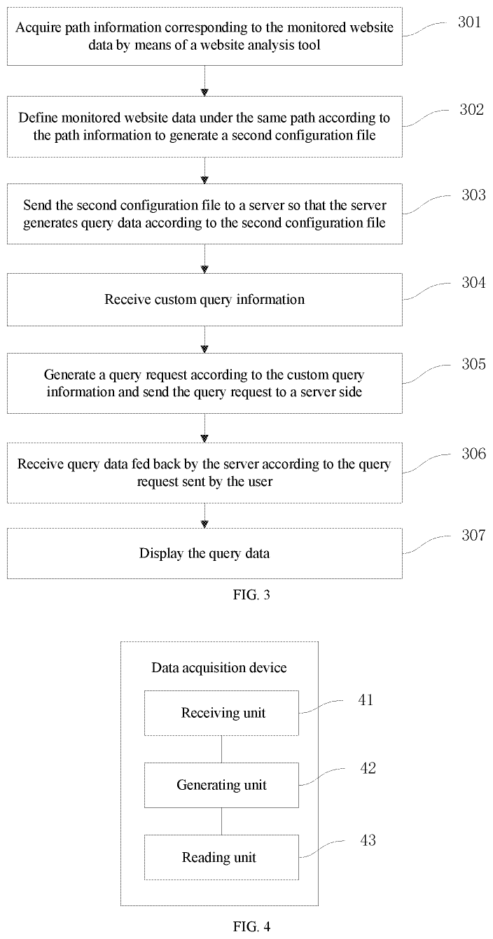

In order to explain the data query method provided by the invention in more detail, in particular to the step of defining the monitored website data according to the path information corresponding to the acquired monitored website data to generate a second configuration file, the embodiment of the invention also provides another data query method, which is shown in FIG. 3 and specifically comprises the steps of:

301. Acquiring path information corresponding to the monitored website data by means of a website analysis tool.

Wherein a website monitoring tool can collect website operation data and provide data support for website optimization, specifically, the path information of the monitored website data can be acquired by collecting website server logs in the website monitoring tool, the website server log herein records the browsing data of a user browsing a webpage; and specifically, the path information of the monitored website data can be acquired by means of JavaScript marks in the website monitoring tool, the data of the user operation at the website is tagged or marked, browsing data of the page browsed by the user is marked with the tags or marks, and thus analysis requirements of different websites are met. According to the embodiment of the invention, the use of a website monitoring tool is not limited.

For the embodiment of the invention, the path information corresponding to the monitored website data may include path visitors with various identities, such as company employees, buyers or competitor employees, and the like, due to the diversity of identities of website visitors, path information corresponding to the monitored website data are acquired by means of a website analysis tool, website visitors with different identities can be mined, and different access authorities can be set for different website visitors; in addition, the path information corresponding to the monitored website data may also include paths under which a user browses the website, such as searching for commodities, purchasing commodities, seeking for help and the like, the path information corresponding to the monitored website data are acquired by means of a website analysis tool, the purposes of website visitors with different identities can be mined, and then convenient access paths can be set for visitors with different purposes. It should be noted that there are different access paths for different visitors, and even visitors who have the same identity and the same purpose may experience different paths for completing a task, for example, some visitors may filter step by step in the classification navigation of a website, some visitors may search for a commodity name in-site, and some visitors may access a commodity page directly through an external search engine. This results in complex access portals and access paths in the path information corresponding to the monitored data.

302. Defining monitored website data under the same path according to the path information to generate a second configuration file.

Because the monitored website data under the same path includes a plurality of users and monitored data corresponding to different elements, and each element in the path has a certain relevance with others, for example, a user usually adds a commodity to the shopping cart or directly purchases after browsing the commodity, therefore, defining the monitored website data under the same path can facilitate the management of the monitored website data by website analysts, information of the associated element can be obtained while the information of a certain element is recorded, for example, the associated information that the user clicks on a certain element and the information of other elements under the same path with the certain element are obtained while the browsing of a certain page is recorded, in this way, the classification of buyers with different identities can be further facilitated, and may specifically include the gender of the user accessing a certain commodity, the age range of the user, the geographical location of the user and the like; obviously, it's also possible to classify according to different patterns of access behavior, such as direct in-site search according to commodity names for information, or step-by-step filtering for information, etc.

It should be noted that the data query method in the prior art cannot flexibly define the attributes of the data, while the embodiment of the invention redefines the monitored website data according to the path information and can thus effectively manage the monitored website data.

303. Sending the second configuration file to a server so that the server generates query data according to the second configuration file.

According to the embodiment of the invention, the second configuration file is sent to a server, so that when the client displays the query data, not only the times of clicks on and accesses to a certain element can be viewed, but also the element data associated with the element can be viewed.

304. Receiving custom query information.

The custom query information herein is query information that a user wants to view data, such as the user wants to view recent purchase data or requests to view a recent browsing record of a commodity, and the like, and this can be realized through query operation through a user interface, such as configuring a plurality of data query options on the user interface, whereby the user can determine the custom query information by selecting different data query options. The embodiment of the present invention does not limit the implementation to receive data query information.

It should be explained that if the user is not satisfied with the displayed query data, the query data displayed on the interface can be configured by modifying the custom query information, so that the query data displayed on the interface can be added, deleted and corrected, for example, if the user wants to know more purchase data, a purchase element can be added on the interface; if the user feels that browsing data does not need to be displayed, the browsing element can be deleted on the page; the embodiment of the invention does not limit the content of the custom query information.

305. Generating a query request according to the custom query information and sending the query request to a server side.

Wherein the query request is a request that a user sends a data query to a server, the query request carries custom query information, the server analyzes the custom query information, for example, the custom query information adds data of a certain element to a request interface, the server selects data corresponding to the element from a database, and feeds the data corresponding to the element back to the client as query data.

306. Receiving query data fed back by the server according to the query request sent by the user.

According to the embodiment of the invention, after the server receives the query request, the data corresponding to the custom query information is acquired from a database according to the custom query information carried in the query request, the query data are generated, and then is fed back to the client.

For example, the custom query information is a request to view user access data, the client generates a query request according to the custom query information and then sends the query request to the server, the server acquires the user access data from a database according to the query request, generates query data and feed the query data back to the client, and then the client receives the user access data fed back by the query request sent by the user.

307. Displaying the query data.

It should be noted that, in the embodiment of the present invention, the manner in which the client displays query data may include, but is not limited to, using iframes, web-embedded Js, or plug-ins.

For the embodiment of the invention, after the client displays the query data, the user can also click to position at a specific element, and the attribute of the element is further filtered to display the filtered data. Obviously, the user can also click to position at a specific element, and the history data of the element is further viewed with the viewed history data displayed. According to the embodiment of the invention, the element data can be displayed at the front end according to the actual requirements of the user. And obviously, the displayed element data may also be configured through an interface operation, and the embodiment of the present invention does not limit this.

It can be seen from the above embodiment, according to another data query method provided by the embodiment of the invention, when the user queries the data, the client can define the monitored website data according to the path information corresponding to the acquired monitored website data to generate a second configuration file so as to facilitate the server to generate the query data according to the second configuration file. Compared with the data query method in the prior art, the client in the embodiment of the invention carries the defined monitored website data according to the path information while sending the acquired monitored website data to the server, so that business personnel can directly carry out data definition, frequent communication with the website party is avoided to a certain extent, and the costs are reduced. In addition, the server analyzes according to the defined monitored website data, binds the elements under the same path to the same event, and enables the client to not only view the times of clicks on and the accesses to an element, but also display the associated data with the element when data are queried by clicking and positioning at the specific element.

In addition, by associating monitored website data under the same path information, data can be analyzed from different dimensions, and different indexes can be displayed, so that when a client displays query data, not only the times of clicks on and accesses to a certain element can be viewed, but also the associated element data with the element can be viewed.

Further, as a specific implementation of the method shown in FIG. 1, the embodiment of the present invention provides a data acquisition device corresponding to the embodiment of the aforementioned method, and the device is not described in detail in the embodiment of the aforementioned method for ease of reading, but it should be clear that the device in the embodiment of the present invention can correspondingly implement the entire content of the embodiment of the aforementioned method, as shown in FIG. 4, the device includes:

a receiving unit 41 for receiving custom data acquisition information;

a generating unit 42 for generating a first configuration file according to the custom data acquisition information; and

a reading unit 43 for reading the first configuration file, acquiring monitored website data according to the first configuration file and sending the monitored website data to the server side.

Further, as shown in FIG. 5, the receiving unit 41 includes:

a positioning module 411 for positioning predefined data from page information;

a determination module 412 for determining data associated with the predefined data according to a selection operation of a user; and

a receiving module 413 for obtaining the custom data acquisition information according to the data associated with the predefined data and the predefined data.

It should be noted that other corresponding description of the functional units involved in the data acquisition device provided by the embodiment of the present invention may be available with reference to the corresponding description in FIG. 1 and will not be described in detail herein.

According to the data acquisition device, the client generates a first configuration file at the client by receiving the custom data acquisition information during data acquisition, and then acquires monitored website data according to the first configuration file and sends the monitored website data to a server, so that element data to be acquired and element data associated with the element data can be selectively acquired. Compared with the data acquisition method in the prior art, before the client sends the monitored website data to the server, the first configuration file generated by the custom data acquisition information is used for acquiring the monitored website data, so that the acquired monitored website data are more standard, facilitating classification of the monitored website data by the server, and meanwhile, the front end is facilitated to query the data according to different query conditions.

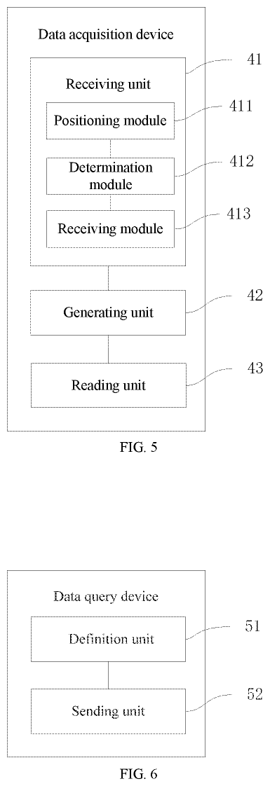

Further, as a specific implementation of the method shown in FIG. 2 and FIG. 3, the embodiment of the present invention provides a data query device corresponding to the embodiment of the aforementioned method, and the device is not described in detail in the embodiment of the aforementioned method for ease of reading, but it should be clear that the device in the embodiment can correspondingly implement the entire content in the embodiment of the aforementioned method, as shown in FIG. 6, the device includes:

a definition unit 51 for defining the monitored website data according to the path information corresponding to the monitored website data acquired by the data acquisition device to generate a second configuration file; and

a sending unit 52 for sending the second configuration file to a server so that the server generates query data according to the second configuration file.

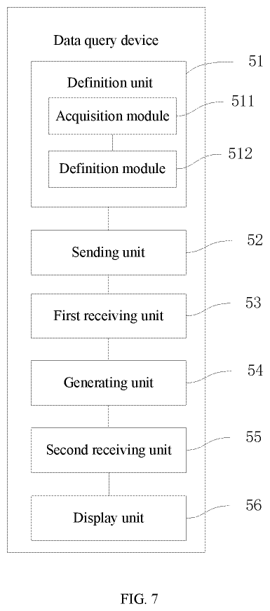

Further, as shown in FIG. 7, the device further comprises:

a first receiving unit 53 for receiving custom query information;

a generating unit 54 for generating a query request according to the custom query information and sending the query request to the server side;

a second receiving unit 55 for receiving the query data fed back by the server according to the query request sent by the user; and

a display unit 56 for displaying the query data.

Further, the definition unit 51 includes:

an acquisition module 511 for acquiring the path information corresponding to the monitored website data by means of a website analysis tool; and

a definition module 512 for defining monitored website data under the same path according to the path information to generate a second configuration file.

It should be noted that other corresponding descriptions of the functional units involved in a data query device provided by an embodiment of the present invention may be available with reference to the corresponding descriptions in FIGS. 2 and 3, which will not be described in detail herein.

According to the data query device provided by the embodiment of the invention, when the user queries the data, the client can define the monitored website data according to the acquired path information corresponding to the monitored website data to generate a second configuration file, so that the server can conveniently generate the query data according to the second configuration file. Compared with the data query method in the prior art, the client in the embodiment of the invention carries the defined monitored website data according to the path information while sending the acquired monitored website data to the server, so that business personnel can directly carry out data definition, frequent communication with the website party is avoided to a certain extent, and the costs are reduced. In addition, the server analyzes according to the defined monitored website data, binds the elements under the same path to the same event, and enables the client to not only view the times of clicks on and the accesses to an element, but also display the associated data with the element when data are queried by clicking and positioning at the specific element.

In addition, by associating monitored website data under the same path information, data can be analyzed from different dimensions, and different indexes can be displayed, so that when a client displays query data, not only the times of clicks on and accesses to a certain element can be viewed, but also the associated element data with the element can be viewed.

The data acquisition device includes a processor and a memory, wherein the receiving unit 41, the generating unit 42, the reading unit 43 and the like are all stored in the memory as program units, and the processor executes the program units stored in the memory to realize corresponding functions.

The data query device includes a processor and a memory, wherein the definition unit 51, the sending unit and the like are stored in the memory as program units, and the processor executes the program units stored in the memory to realize corresponding functions.

The processor includes a core, and the core is used for calling a corresponding program unit from a memory. One or more cores can be provided, manpower is saved by adjusting core parameters, so that at a front end, not only the times of clicks on and accesses to elements can be viewed, but also associated data of the elements can be displayed.

The memory may include non-permanent memory, random access memory (RAM), and/or non-volatile memory in a computer-readable medium, such as read only memory (ROM) or flash RAM, the memory including at least one memory chip.

The embodiment of the present invention provides a storage medium having stored thereon a program that, when executed by a processor, implements the data acquisition method.

The embodiment of the invention provides a processor, which is used for running a program, wherein the program executes the data acquisition method when running. The embodiment of the present invention also provides a storage medium having stored thereon a program that, when executed by a processor, implements the data query method.

The embodiment of the invention also provides a processor which is used for running a program, wherein the program executes the data query method when running.

The embodiment of the invention provides a device, which includes a processor, a memory and a program stored on the memory and capable of running on the processor, the processor implementing the following step when running the program:

a data acquisition method, including: receiving custom data acquisition information; generating a first configuration file according to the custom data acquisition information; reading the first configuration file, acquiring monitored website data according to the first configuration file and sending the monitored website data to a server side.

Further, the receiving custom data acquisition information includes: positioning predefined data from page information; determining the data associated with the predefined data according to a selection operation of a user; and obtaining custom data acquisition information according to the data associated with the predefined data and the predefined data.

The embodiment of the invention also provides a device, which includes a processor, a memory and a program stored on the memory and capable of running on the processor, the processor implementing the following step when running the program:

a data query method, including: defining the monitored website data according to path information corresponding to the acquired monitored website data to generate a second configuration file; and sending the second configuration file to a server so that the server generates query data according to the second configuration file.

Further, defining the monitored website data according to the path information corresponding to the monitored website data and generating a second configuration file includes: acquiring path information corresponding to the monitored website data by means of a website analysis tool; and defining monitored website data under the same path according to the path information to generate a second configuration file.

Further, the method further includes: receiving query data fed back by the server according to a query request sent by a user; and displaying the query data.

Further, before receiving the query data fed back by the server according to the query request sent by the user, the method further includes: receiving custom query information; and generating a query request according to the custom query information and sending the query request to a server side.

The devices herein may be servers, PCs, PADs, cell phones, etc.

The present application also provides a computer program product adapted, when executed on a data processing device, to execute a program code initialized with the method steps of: receiving custom data acquisition information; generating a first configuration file according to the custom data acquisition information; reading the first configuration file, acquiring monitored website data according to the first configuration file, sending the monitored website data to a server side, further defining the monitored website data according to path information corresponding to the acquired monitored website data to generate a second configuration file; and sending the second configuration file to a server so that the server generates query data according to the second configuration file.

Those skilled in the art will appreciate that embodiments of the present application may be provided as a method, system, or computer program product. Thus, the present application may take the form of an entirely hardware embodiment, an entirely software embodiment, or an embodiment combining software and hardware aspects. Moreover, the present application may take the form of a computer program product embodied on one or more computer-usable storage media (including, but not limited to, magnetic disk storage, CD-ROM, optical storage, and the like) having computer-usable program code embodied therein.

The present application is described with reference to flowchart and/or block diagrams of methods, device (systems), and computer program products according to embodiments of the present application. It is to be understood that each flow and/or block of the flowcharts and/or block diagrams, and combinations of flows and/or blocks in the flowcharts and/or block diagrams, can be implemented by computer program instructions. These computer program instructions may be provided to a processor of a general purpose computer, special purpose computer, embedded processor, or other programmable data processing device to produce a machine, such that the instructions, which execute via the processor of the computer or other programmable data processing device, produce means for implementing the functions specified in the flowchart block or blocks and/or block diagram block or blocks.

These computer program instructions may also be stored in a computer-readable memory that can direct a computer or other programmable data processing device to function in a particular manner, such that the instructions stored in the computer-readable memory produce an article of manufacture including instruction means which implement the function specified in the flowchart block or blocks and/or block diagram block or blocks.

These computer program instructions may also be loaded onto a computer or other programmable data processing device to cause a series of operational steps to be performed on the computer or other programmable device to produce a computer implemented process such that the instructions which execute on the computer or other programmable device provide steps for implementing the functions specified in the flowchart block or blocks and/or block diagram block or blocks.

In a typical configuration, a computing device includes one or more processors (CPUs), input/output interfaces, network interfaces, and memory.

The memory may include non-volatile memory in a computer-readable medium, random access memory (RAM), and/or non-volatile memory, such as read only memory (ROM) or flash RAM. Memory is an example of a computer-readable medium.

Computer readable media, including both permanent and non-permanent, removable and non-removable media, may implement information storage by any method or technique. The information may be computer readable instructions, data structures, modules of a program, or other data. Examples of storage media for a computer include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, compact disc read only memory (CD-ROM). A digital versatile disk (DVD) or other optical storage, magnetic cassettes, magnetic tape-magnetic disk storage or other magnetic storage devices, or any other non-transmission medium, can be used to store information that can be accessed by a computing device. As defined herein, computer-readable media does not include computer-readable transitory media, such as modulated data signals and carrier waves.

The above are merely examples of the present application and are not intended to limit the present application. Various modifications and alterations of this application will occur to those skilled in the art. Any modifications, equivalents, improvements and so on that come within the spirit and principles of this application are intended to be within the scope of the claims appended hereto.

What is claimed is:

1. A data acquisition method, characterized by comprising:
receiving custom data acquisition information;
generating a first configuration file according to the custom data acquisition information; and
reading the first configuration file, acquiring monitored website data according to the first configuration file and sending the monitored website data to a server side.

2. The method according to claim 1, wherein receiving custom data acquisition information comprises:
positioning predefined data from page information;
determining data associated with the predefined data according to selection operation of a user; and
obtaining the custom data acquisition information according to the data associated with the predefined data and the predefined data.

3. A data query method, characterized by comprising:
defining the monitored website data according to path information corresponding to the monitored website data of claim 1 to generate a second configuration file; and
sending the second configuration file to a server so that the server generates query data according to the second configuration file.

4. The method according to claim 3, characterized in that defining the monitored website data according to the path information corresponding to the monitored website data to generate a second configuration file comprises:
acquiring path information corresponding to the monitored website data by means of a website analysis tool; and
defining monitored website data under the same path according to the path information to generate a second configuration file.

5. The method according to claim 3, characterized by further comprising:
receiving query data fed back by the server according to a query request sent by a user; and
displaying the query data.

6. The method according to claim 5, characterized in that before receiving the query data fed back by the server according to the query request sent by the user, the method further comprises:
receiving custom query information; and
generating a query request according to the custom query information and sending the query request to a server side.

7. A storage medium, characterized by comprising a stored program, wherein a device in which the storage medium locates is controlled to execute the data acquisition method of either claim 1 when the program is running.

8. A storage medium, characterized by comprising a stored program, wherein a device in which the storage medium locates is controlled to execute the data query method of any of claims 3 when the program is running.
